(19) United States
(12) Patent Application Publication
(10) Pub. No.: US 2004/0172299 A1
(43) Pub. Date: Sep. 2, 2004

(54) System and method for facilitating clinical care

(76) Inventor: Eric S. Paul, North York (CA)

Correspondence Address: FRANCIS J. KOWALIK, ESQ., Corporate Counsel, Law Department, BAXTER INTERNATIONAL, INC., One Baxter Parkway, DF3-2E, Deerfield, IL, 60015, US

(21) Appl. No.: 10/747,874

(22) Filed: Dec. 29, 2003

Related U.S. Application Data
(60) Provisional application No. 60/437,201, filed on Dec. 31, 2002.

(51) Int. Cl. G06F 17/60

(52) U.S. Cl. 705/2

(57) ABSTRACT

A system and method for facilitating a clinical intervention involving a healthcare provider and a patient is disclosed. A window enables healthcare personnel to access a plurality of reference codes for documenting the clinical intervention. Each of the plurality of reference codes are pre-defined by a healthcare facility and include at least one parameter. Healthcare personnel document the clinical intervention by selecting among the pre-defined parameters to characterize the clinical intervention.

### RELATED APPLICATIONS

This application claims priority from Provisional Patent Application Serial No. 60/437,201 filed Dec. 31, 2002.

### TECHNICAL FIELD

The present invention generally relates to facilitating clinical healthcare of a patient. More specifically, the present invention is directed to documenting clinical interventions involving a healthcare provider and a patient.

### BACKGROUND OF THE INVENTION

Healthcare facilities utilize many resources to treat a patient. These resources may include various medical personnel, prescribed drugs, laboratory testing, clinical studies, clinical interventions, etc. A clinical intervention is any action taken by healthcare personnel to optimize therapy, enforce policies and procedures, or avoid adverse drug reactions. Throughout the patient's treatment, many individuals may be involved. Keeping track of the various treatments, results, and medical personnel utilized during the patient's treatment can be difficult. Due to extensive human involvement during treatment of an individual, recording and utilizing information acquired through a clinical intervention is routinely susceptible to human error. A lack of communication among medical personnel can adversely affect the patient's condition as well as the efficient use of medical resources.

It would be beneficial for both the patient and the healthcare facility to utilize a system wherein important information garnered through clinical interventions is accurately documented and recorded. Similarly, a degree of control over the information provided to medical personnel for documenting the clinical intervention is desirable to improve the quality and consistency of patient healthcare, e.g., patient history records, adverse drug reactions, management of medical personnel, etc.

Often times, medical personnel do not have access to pertinent patient records. And if the records are accessible, the information is old and ineffective. There is a need to ensure the timeliness of recorded patient information so that subsequent decisions based on the patient's status or condition will be more accurate and effective.

The present invention is provided to solve these and other problems.

### SUMMARY OF THE INVENTION

The present invention is directed to a system and method for facilitating a clinical intervention involving a healthcare provider and a patient. The system includes a window enabling access to a plurality of reference codes for documenting a clinical intervention. Each of the plurality of reference codes being stored on the system and include at least one pre-defined parameter. The plurality of reference codes includes one or more of the following: problem, severity, recommendation, outcome, and status. The problem reference code comprises a list of clinical intervention problem descriptions. The severity reference code comprises a table of clinical intervention severity descriptions. The recommendation reference code comprises a table of clinical intervention recommendation descriptions. The outcome reference code comprises a table of clinical intervention outcome descriptions. The status reference code comprises a table of clinical intervention status descriptions. Additional entries to the respective reference codes can be added wherein the healthcare provider selects among the pre-defined parameters to characterize the clinical intervention.

An object of the present invention is to facilitate clinical healthcare of a patient by providing the ability to document real-time concerns about a patient's clinical care or status, preferably involving medication regimes, patient monitoring parameters, and lab results; and subsequently communicate recommendations for patient care based on an assessment of the patient's condition or status.

A further object of the present invention is to provide a patient-centric system and method for documenting clinical interventions. The documentation being capable of providing a history of all interventions by patient and other numerous criteria.

Other advantages and aspects of the present invention will become apparent from the following description of the drawings and detailed description of the invention.

### BRIEF DESCRIPTION OF THE DRAWINGS

FIG. 1 depicts a window displaying a list of clinical interventions for a particular patient;

FIG. 2 depicts a window displaying expanded information of a specified clinical intervention;

FIG. 3 depicts a window displaying clinical information associated with the intervention tab;

FIG. 4 depicts a window displaying clinical information associated with the outcome tab;

FIG. 5 depicts a window displaying a list of facility-defined outcomes available for selection by healthcare personnel during recording of a clinical intervention;

FIG. 6 depicts a window displaying a list of facility-defined problems available for selection by healthcare personnel during recording of a clinical intervention;

FIG. 7 depicts a window displaying a list of facility-defined specific problems available for selection by healthcare personnel during recording of a clinical intervention;

FIG. 8 depicts a window displaying a list of facility-defined recommendations available for selection by healthcare personnel during recording of a clinical intervention;

FIG. 9 depicts a window displaying a list of facility-defined severities available for selection by healthcare personnel during recording of a clinical intervention;

FIG. 10 depicts a window displaying a list of facility-defined statuses available for selection by healthcare personnel during recording of a clinical intervention;

FIG. 11 depicts a window displaying various clinical intervention parameters defined by the healthcare facility and provided to healthcare personnel for selection during recording or reviewing of a clinical intervention; and,

FIG. 12 is a block diagram of a network including one embodiment of the present invention.

### DETAILED DESCRIPTION OF THE PREFERRED EMBODIMENT

While the present invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is directed to facilitating clinical care of a patient. A clinical intervention is any action taken by a healthcare provider/personnel to optimize therapy, enforce policies and procedures, and avoid adverse drug reactions. The clinical intervention can be utilized to document and follow-up therapeutic interventions. When a clinical intervention is recorded for a specific patient, healthcare personnel involved in the patient's care are able to receive a message, e.g., recommendation, concerning the intervention. The recommendation message can be transmitted as a message to a specific individual or members of a particular group or unit involved with the patient's treatment, e.g., a pharmacist(s), ICU, etc. Any response to the message can also be documented, recorded, and transmitted.

Referring to FIG. 12, a module 70 provides a comprehensive application useful to healthcare personnel involved with clinical interventions. The module 70 facilitates documenting, tracking, monitoring, and communicating among healthcare personnel, e.g., transmitting a recommendation message to involved healthcare personnel allowing them to act or process the recommendation accordingly. Healthcare personnel are in communication with the module 70 via a variety of means, e.g., wireless devices, PDAs, hand-held computers, network terminals, telephones, etc. Through a patient profile window, healthcare personnel can quickly access all outstanding interventions for a particular patient.

Patient-centric clinical documentation begins at the patient's profile window where an indicator, e.g., button, designating “clinical intervention” is illuminated if an outstanding intervention has been recorded for the patient. Once accessed, a clinical intervention window 10 shown in FIG. 1 will be displayed providing a brief synopsis of the clinical intervention documents thus far on the patient's profile. Preferably, the clinical interventions are displayed in reverse-chronological order. Columns related to status and severity can be implemented to identify an associated urgency level of the clinical intervention. Accessing any row displayed in the window enables healthcare personnel to review and report on the clinical intervention. The patient profile window also provides healthcare personnel with the ability to add a new clinical intervention to the profile, search or sort the list of clinical interventions, and edit or append to an existing clinical intervention.

To assist the recording of clinical interventions into the system, a plurality of reference codes utilized for characterizing the clinical intervention can be established within the module 70 and set up by the managing healthcare facility. The sets of reference codes for reporting and displaying the clinical intervention can be accessed by healthcare personnel through various integrated drop-down lists or tables. Each reference code may pertain to a specific parameter of the clinical intervention. For example, information relating to outcome, problem, severity, recommendation, outcome, or status can be provided and defined by the healthcare facility through the drop-down menu for selection by healthcare personnel during documenting of the clinical intervention. If a desired description is not available through a pop-up window or drop-down menu—or additional information is required—medical personnel can utilize a free-text area to include the information.

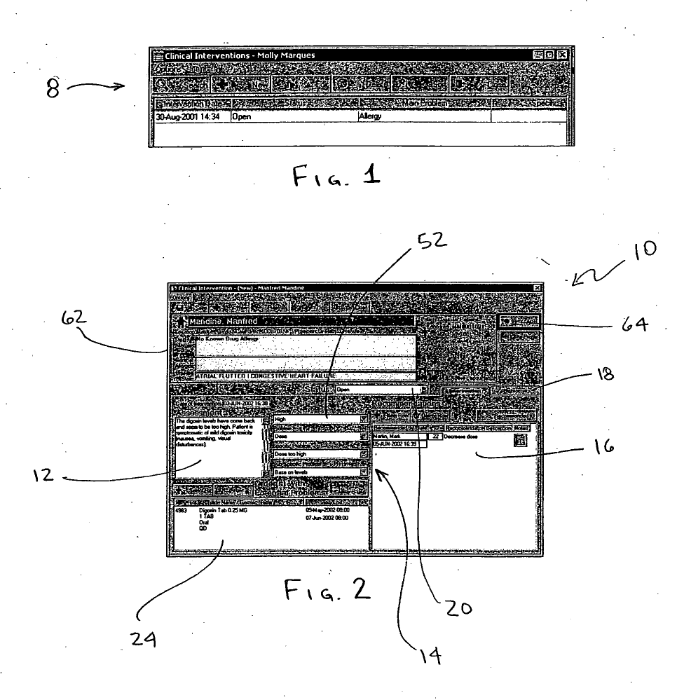

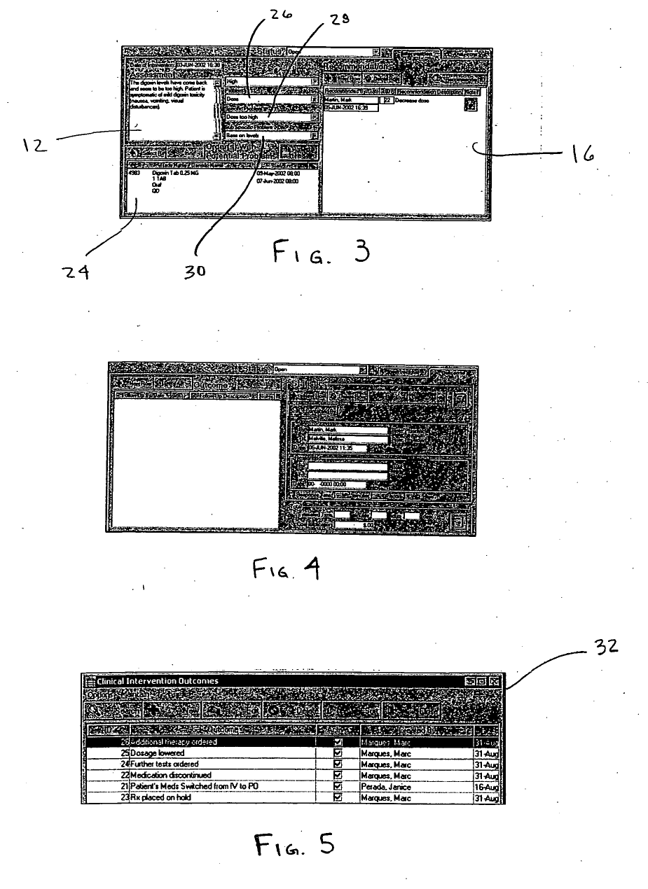

One embodiment of the clinical intervention format is shown in FIG. 2 and is preferably apportioned into several segments: patient assessment 12, problem identification 14, recommendations 16, outcome/follow-up 18, and status 20. Each healthcare facility is provided the capability to customize among several options related to each reference code. FIGS. 3 and 4 depict windows accessed by clicking the intervention or outcome tabs displayed in the window shown in FIG. 2. The additional windows further facilitate documenting the intervention. Existing healthcare facility codes can be utilized for quick, user-friendly report generation. If the clinical intervention is unique, the free-text field can be utilized. In addition, the free-text note entry is also provided for those instances where specific or additional information may be desired.

One of the initial steps involved in a clinical intervention involves making an assessment of the patient. A free-text field is available to document the patient's current condition/status. Previous patient results are able to be viewed during entry of the intervention. After the assessment is completed, the healthcare provider can identify potential drug therapy problems 24. A variety of facility-defined problems 26, sub-problems 28, and sub-specific problems 30 are available for selection by healthcare personnel.

The assessment window 12 provides a free-text area to healthcare personnel for recording the assessment of the patient during the clinical intervention. The free-text area includes sufficient capacity to manage the various descriptions expected to be entered by healthcare personnel during clinical interventions. The capacity of the free-text area can be modified and increased/decreased according to the preferences of the healthcare facility.

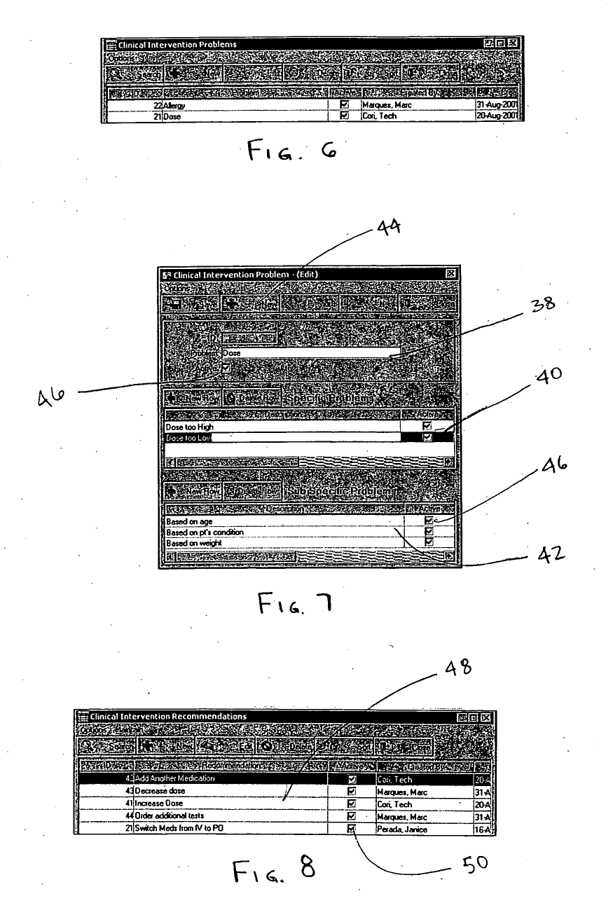

An outcome table 32 shown in FIG. 5 comprises text descriptions of the outcomes of clinical interventions. When recording a clinical intervention, healthcare personnel may select from a facility-defined list displayed in the table. Selection of an outcomes tab enables the outcome table 32 to be displayed. The healthcare facility may increase, decrease, or modify the outcome descriptions to enable medical personnel to more accurately record the clinical intervention.

A problem table shown in FIGS. 6 and 7 provides a list of problems that are generally expected to require a clinical intervention. Within each facility-defined intervention, there are several facility-defined problems to assist medical personnel in classifying drug related issues. During recording of the clinical intervention, medical personnel can select from a facility-defined list of problems shown in FIG. 6. Each problem may further include a list of specific problems 40, and each specific problem can further include a list of sub-specific problems 42. Through this problem classification, healthcare personnel are able to subsequently monitor a number of clinical intervention characteristics that may be utilized to improve patient care.

To add a new item to the problem list, the “new” button 44 is accessed from the problem page 38 wherein the description can be entered when the window appears. Specific 40 and sub-specific 42 problems can also be attached as shown in FIG. 7. Preferably, an active check box 46 is utilized to regulate the accessibility of each defined problem item. The healthcare facility may regulate the accessibility of many items to medical personnel by utilizing—clearing or checking—the active check box 46.

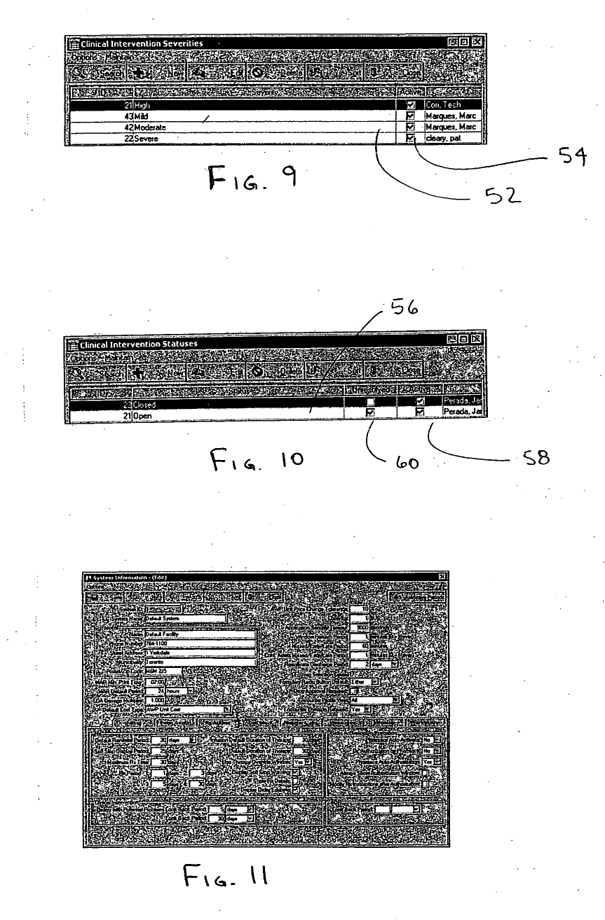

After defining a potential problem, healthcare personnel may suggest changes in drug therapy or make recommendations to the healthcare team or physician. Shown in FIG. 8, a number of recommendations are made available for each intervention documented and prioritized according to the healthcare facility's preference. Recommendations may include changes to the patient's therapeutic regimen through modifying, discontinuing, or adding new drug therapy. Each recommendation may be selected from a facility-defined table or pull-down menu; or if unique, may be directly input into the intervention.

Recommendations are transmitted in real-time to pertinent medical personnel for review. Healthcare personnel may choose to accept one, some, or all of the recommendations provided; or reject all the recommendations. If all the recommendations are rejected, the healthcare personnel are prompted to submit a reason. A set of facility-defined reasons are provided to the medical personnel in a drop-down table. A reason maybe selected from the list of provided reasons or entered as free-text information accordingly.

In FIG. 8, a recommendations table 48 provides text descriptions of recommendations available for selection by healthcare personnel. During recording of a clinical intervention, medical personnel may select from one or more recommendations listed in the table 48. Similar to the other reference codes, new recommendations can also be added to the list and made available to healthcare personnel for later selection. The status of a corresponding active box 50 similarly designates whether the associated recommendation description is available to medical personnel during clinical intervention documenting.

During the recording of a clinical intervention, healthcare personnel may choose from among a variety of severity levels provided in a list 52 and shown in FIG. 9. The various severity levels, e.g., high, mid, moderate, low, etc., are available in a pull-down menu for quick selection by healthcare personnel. An active check box 54 can also be employed to regulate the use of the reference code, as well as adding information to the page.

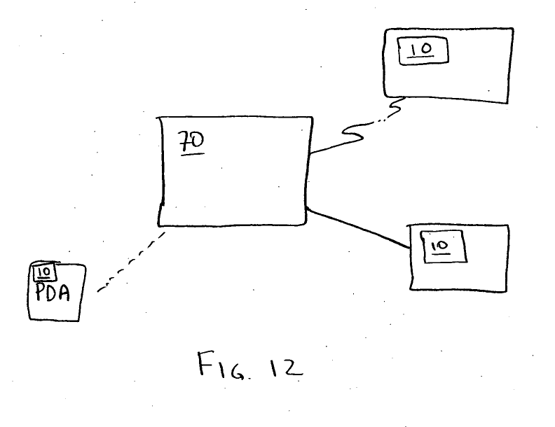

As seen in FIG. 10, clinical intervention status descriptions are provided in a table 56 to medical personnel. During clinical intervention recording, healthcare personnel may select from a variety of status descriptions listed. Additional status descriptions can be added to the list as well as activated or de-activated 58. In addition, an unresolved status can be identified by selecting an unresolved checkbox 60.

Statistics related to clinical interventions are also maintained and various reports can be generated to provide the ability to monitor personnel involved with each intervention and resolution, time duration, and cost implications. These reports can be automatically generated as the clinical intervention is recorded. Although automatically determined, the statistics can be adjusted to reflect the actual data, if necessary. This data is then available for incorporation into reports generated across numerous criteria.

At any time in the process, healthcare personnel may generate a follow-up schedule to facilitate organization of associated clinical activities. The follow-up schedule alerts healthcare personnel of the pending patient matters to follow-up with and ensure treatment is appropriate. During each follow-up visit, patient notes can be documented in the free-text field. The process repeats itself if additional assessments and clinical intervention need to be performed. Through documentation of the clinical intervention in this way, healthcare personnel are provided on-line retrieval of necessary data elements regarding patient care or healthcare facility levels. A full audit trail of each element of the intervention is available.

To further assist in the understanding of the present invention, an example is provided. Documentation of a clinical intervention is recorded in the clinical intervention window 10 shown in FIG. 2. From a patient profile window, medical personnel select, e.g., click, an Rx intervention button. If a clinical intervention has previously been recorded for this patient, the Rx intervention button may appear with a colored border. Selection of the Rx intervention button brings up a main clinical interventions window for that patient 8, FIG. 1. All clinical interventions for this patient will be listed in the window. If a new clinical intervention is being documented, medical personnel will click the new button. An existing clinical intervention can be updated by selecting the clinical intervention, e.g., double-clicking the clinical intervention. This action will bring up the clinical intervention window 10 shown in FIG. 2. If the selected intervention has been resolved, medical personnel may view its details, but further updates cannot be made. The top portion of the clinical intervention window 10 displays a summary of the patient encounters and patient demographics 62. Preferably, this information can only be edited from outside the clinical intervention window 10.

If there has been one or more adverse treatment reactions recorded for this patient, an ADR button 64 has a color or flashing border around it. If an intervention involves an adverse drug reaction, medical personnel will have recorded the adverse drug reaction. Clicking the ADR button 64 enables a review of any reactions. Information about the clinical intervention and outcome can be entered or updated as necessary. Additional information can be entered or updated by selecting the status 20 and outcome 18 tabs. Personnel contact information on the outcome tab should be entered. The entered information can be saved by clicking the save button.

When a clinical intervention is recorded, a distinguishing characteristic, e.g., red band, will appear around the Rx intervention button in the patient profile window to alert medical personnel that there has been a clinical intervention for this patient. In addition, a message is sent alerting all individuals of a healthcare unit assigned to treating the patient. The unit is informed of the intervention and a message is sent to other medical personnel, e.g., physician, involved with treating the patient.

For a new intervention, the date of the intervention can be entered by clicking to select a date from the calendar. Details of an assessment are entered in the free-text area. The severity of the intervention can be included in the documenting by selecting the appropriate level from the facility-defined list 52.

Medical personnel may include documentation of a problems related to the clinical intervention. As with the other reference codes, various descriptions of problems associated with an intervention are provided to medical personnel for selection. Additional problems 38, specific problems 40, and sub-specific problems 42 can be added to the system by the healthcare facility.

The clinical intervention may be associated with one or more orders. All orders that have been identified as causing potential problems for this intervention are listed in this section 24. To review the treatment administered to the patient, medical personnel can click the button marked Med Admin History. Any order that may be causing a problem can be monitored by selecting the appropriate order. Also, if an order was determined as not being the cause of a problem, but was previously selected, it can be removed simply by unselecting it.

Recommendations 16 for action or treatment of the patient can be submitted through the system to any combination of medical personnel involved with treating the patient. Some of the information included with the recommendation includes the identity of the individual that proffered the recommendation, the date and time of the recommendation, and a recommendation ID and description. To add a new recommendation, medical personnel may click in the ID field and select a recommendation from the list defined and provided by the healthcare facility.

Medical personnel are provided an indicator to show whether notes are attached to the recommendation. If it is desired to provide additional notes, e.g., to expand on the recommendation, the notes button can be selected and the details entered. Preferably, a notes button will appear like a gray, blank piece of paper if there are no notes attached. If there are notes attached to the recommendation, the notes button appears as a white piece of paper with lines and a heavy black border. By design, the system will default to the medical personnel signed on for documenting the intervention. A date for the recommendation must be set and selected from the calendar. The information is saved by clicking the save button. Once saved, the note is stamped with the identity of the medical personnel, date, and time; and cannot be changed.

The outcome area shown in FIG. 4 is used to record outcomes, contact and response information, and other statistics. The outcome area also lists recorded follow-ups. These include the medical personnel that followed-up the clinical intervention, the date and time of the follow-up, and a follow-up ID and description. Notes may also be attached to the follow-up. To record a new follow-up, medical personnel click the new row button. Generally, the follow-up defaults to the user currently signed on. The follow-up can be changed by clicking and selecting the appropriate medical personnel approved by the healthcare facility. The follow-up date must be set wherein the appropriate date from the calendar is selected. Medical personnel can click on the ID field and select the appropriate follow-up from the list.

A statistics area also shown in FIG. 4 includes record information about contacts, responses, response times, and overall time duration and cost statistics. Notes can be recorded about contacts/responses, as well as about the overall time and cost statistics.

Each clinical intervention recorded must have a contact person. For an initial contact or response, the area will be blank and the necessary information must be completed. For a follow-up contact or response, the contact and/or response area may already be completed. Previous contacts and responses may be available by scrolling through a record. If needed, the appropriate information for the contact and/or response should be entered. This individual will receive a message about the intervention. The response time is automatically calculated based on the date and time of the initial contact and response. Additional information can be recorded in the notes via the notepad button. If necessary, the total estimated time and total cost implications can be updated. Additional information about the total estimated time and cost implications can be entered and saved. Once contact and response information has been entered, it can be updated.

Various parameters in system information can be set up to retrieve clinical interventions in the system. Referring to FIG. 11, these parameters establish the look back periods for displaying clinical interventions. When medical personnel access clinical interventions for a patient, the pre-defined parameters will determine the look back period for which documented clinical interventions will be displayed. The healthcare facility can define this time period in hours, days, or weeks.

For additional understanding of the present invention, the following materials and disclosures are herein incorporated by reference:

| Patent No. | Owner/Assignee | Title |
|---|---|---|
| U.S. Pat. No. 4,785,969 | Pyxis | Medication Dispensing System |
| U.S. Pat. No. 4,835,372 | Clincom Inc. | PATIENT CARE SYSTEM |
| U.S. Pat. No. 4,847,764 | Cardinal/Owen | SYSTEM FOR DISPENSING DRUGS IN HEALTH CARE |
| | Health/Medtrol | INSTITUTIONS |
| U.S. Pat. No. 4,850,009 | Clinicom | PORTABLE HANDHELD TERMINAL INCLUDING OPTICAL |
| | | BAR CODE READER AND ELECTROMAGNETIC |
| | | TRANSCEIVER MEANS FOR INTERACTIVE WIRELESS |
| | | COMMUNICATION WITH A BASE COMMUNICATIONS |
| | | STATION |
| U.S. Pat. No. 4,857,713 | Jack D. Brown | HOSPITAL ERROR AVOIDANCE SYSTEM |
| U.S. Pat. No. 5,077,666 | Eclipsys/Emtek | MEDICAL INFORMATION SYSTEM WITH AUTOMATIC |
| | | UPDATING OF TASK LIST IN RESPONSE TO CHARTING |
| | | INTERVENTIONS ON TASK LIST WINDOW INTO AN |
| | | ASSOCIATED FORM |
| U.S. Pat. No. 5,291,399 | Elot/Executone | METHOD AND APPARATUS FOR ACCESSING A PORTABLE |
| | | PERSONAL DATABASE AS FOR A HOSPITAL |
| | | ENVIRONMENT |
| U.S. Pat. No. 5,301,105 | AllCare/Cummings | ALL CARE HEALTH MANAGEMENT SYSTEM |
| U.S. Pat. No. 5,314,243 | McKesson/Auto | Portable Nursing Center |
| | Healthcare | |
| U.S. Pat. No. 5,319,543 | First Data Health | WORKFLOW SERVER FOR MEDICAL RECORDS IMAGING |
| | | AND TRACKING SYSTEM |
| U.S. Pat. No. 5,404,384 | Medecorx/Diebold | Inventory Monitoring Apparatus Employing Counter for Adding and |
| | | Subtracting Objects being Monitored |
| U.S. Pat. No. 5,445,294 | Pyxis | Method for Auytomatic Dispensing of Articles Stored in Cabinet |
| U.S. Pat. No. 5,455,851 | Executone | System for Identifying Object Locations |
| U.S. Pat. No. 5,460,294 | Pyxis | Single Does Pharmaceutical Dispenser Subassembly |
| U.S. Pat. No. 5,465,082 | Executone | Apparatus for Automating Routine Communication in a Facility |
| U.S. Pat. No. 5,471,382 | McKesson/Access | MEDICAL NETWORK MANAGEMENT SYSTEM AND |
| | | PROCESS |
| U.S. Pat. No. 5,520,450 | Pyxis | Supply Station with Internal Computer |
| U.S. Pat. No. 5,533,079 | Medecorx/Diebold | Inventory Monitoring Apparatus |
| U.S. Pat. No. 5,536,084 | Grandview Hospital | MOBILE NURSING UNIT AND SYSTEM THEREFOR |
| U.S. Pat. No. 5,558,638 | Healthdyne | PATIENT MONITOR AND SUPPORT SYSTEM |
| U.S. Pat. No. 5,564,803 | McKesson/Auto | Portable Nursing Center |
| | Healthcare | |
| U.S. Pat. No. 5,594,786 | Elot/Executone | PATIENT CARE AND COMMUNICATION SYSTEM |
| U.S. Pat. No. 5,597,995 | Automated | AUTOMATED MEDICAL PRESCRIPTION FULFILLMENT |
| | Prescriptions | SYSTEM HAVING WORK STATIONS FOR IMAGING, |
| | | FILLING, AND CHECKING THE DISPENSED DRUG |
| | | PRODUCT |
| U.S. Pat. No. 5,641,892 | DEKA | Intravenous-Line Air-Detection System |
| U.S. Pat. No. 5,689,229 | Executone | Patient Care and Communication System |
| U.S. Pat. No. 5,713,856 | DEKA | Intravenous-Line Air Elimination System |
| U.S. Pat. No. 5,745,366 | Omnicell | Pharmaceutical Dispensing Device and Methods |
| U.S. Pat. No. 5,755,683 | DEKA | Stopcock Valve |
| U.S. Pat. No. 5,764,923 | McKesson/Access | MEDICAL NETWORK MANAGEMENT SYSTEM AND |
| | | PROCESS |
| U.S. Pat. No. 5,772,635 | McKessin or Alaris | AUTOMATED INFUSION SYSTEM WITH DOSE RATE |
| | | CALCULATOR |
| U.S. Pat. No. 5,772,637 | DEKA | Intravenous-Line Flow-Control System |
| U.S. Pat. No. 5,781,442 | Alaris | SYSTEM AND METHOD FOR COLLECTING DATA AND |
| | | MANAGING PATIENT CARE |
| U.S. Pat. No. 5,790,409 | Medecorx/Diebold | INVENTORY MONITORING AND DISPENSING SYSTEM FOR |
| | | MEDICAL ITEMS |
| U.S. Pat. No. 5,805,456 | Omnicell | Method and Devices for Providing Access to Items to be Dispensed |
| U.S. Pat. No. 5,833,599 | Multum | PROVIDING PATIENT-SPECIFIC DRUG INFORMATION |
| U.S. Pat. No. 5,842,976 | Pyxis | DISPENSING, STORAGE, CONTROL AND INVENTORY |
| | | SYSTEM WITH MEDICATION AND TREATMENT CHART |
| | | RECORD |
| U.S. Pat. No. 5,848,593 | Medecorx/Diebold | SYSTEM FOR DISPENSING A KIT OF ASSOCIATED |
| | | MEDICAL ITEMS |
| U.S. Pat. No. 5,857,967 | Univ. of Illinois | UNIVERSALLY ACCESSIBLE HEALTHCARE DEVICES WITH |
| | | ON THE FLY GENERATION OF HTML FILES |
| U.S. Pat. No. 5,897,493 | Health Hero | MONITORING SYSTEM FOR REMOTELY QUERYING |
| | | INDIVIDUALS |
| U.S. Pat. No. 5,905,653 | Omnicell | Method and Devices for Dispensing Pharmaceutical and Medical |
| | | Items |
| U.S. Pat. No. 5,912,818 | Medecorx/Diebold | SYSTEM FOR TRACKING AND DISPENSING MEDICAL |
| | | ITEMS |
| U.S. Pat. No. 5,924,074 | Azron | ELECTRONIC MEDICAL RECORDS SYSTEM |
| U.S. Pat. No. 5,940,306 | Pyxis | Drawer Operating System |
| U.S. Pat. No. 5,941,846 | Alaris | METHOD AND APPARATUS FOR POWER CONNECTION IN |
| | | A MODULAR PATIENT CARE SYSTEM |
| U.S. Pat. No. 5,946,659 | Clinicomp | SYSTEM AND METHOD FOR NOTIFICATION AND ACCESS |
| | | OF PATIENT CARE INFORMATION BEING |
| | | SIMULTANEOUSLY ENTERED |
| U.S. Pat. No. 5,956,487 | Hewlett-Packard | Embedding Web Access Mechanism in an Appliance for User |
| | | Interface Functions Including a Web Browser |
| U.S. Pat. No. 5,960,403 | Health Hero | Health Management System |
| U.S. Pat. No. 5,964,700 | McKesson/Access | MEDICAL NETWORK MANAGEMENT ARTICLE OF |
| | | MANUFACTURE |
| U.S. Pat. No. 5,971,593 | Medecorx/Diebold | DISPENSING SYSTEM FOR MEDICAL ITEMS |
| U.S. Pat. No. 5,993,046 | Medecorx/Diebold | SYSTEM FOR DISPENSING MEDICAL ITEMS BY BRAND OR |
| | | GENERIC NAME |
| U.S. Pat. No. 5,997,476 | Health Hero | NETWORKED SYSTEM FOR INTERACTIVE |
| | | COMMUNICATION AND REMOTE MONITORING OF |
| | | INDIVIDUALS |
| U.S. Pat. No. 6,003,006 | Pyxis | SYSTEM OF DRUG DISTRIBUTION TO HEALTH CARE |
| | | PROVIDERS |
| U.S. Pat. No. 6,011,999 | Omnicell | Apparatus for Controlled Dispensing of Pharmaceutical and Medical |
| | | Supplies |
| U.S. Pat. No. 6,018,713 | Coli, et al. | INTEGRATED SYSTEM AND METHOD FOR ORDERING AND |
| | | CUMULATIVE RESULTS REPORTING OF MEDICAL TESTS |
| U.S. Pat. No. 6,021,392 | Pyxis | SYSTEM AND METHOD FOR DRUG MANAGEMENT |
| U.S. Pat. No. 6,039,467 | Omnicell | Lighting System and Methods for Dispensing Device |
| U.S. Pat. No. 6,065,819 | Pyxis | Jerk-Resistant Drawer Operating System |
| U.S. Pat. No. 6,070,761 | Deka | Vial Loading Mechanism |
| U.S. Pat. No. 6,074,345 | Univ. of Fla. | PATIENT DATA ACQUISITION AND CONTROL SYSTEM |
| U.S. Pat. No. 6,101,478 | Health Hero | MULTI-USER REMOTE HEALTH MONITORING SYSTEM. |
| | | Priority 1/25/93. |
| U.S. Pat. No. 6,108,588 | Medecorx/Diebold | RESTOCKING METHOD FOR MEDICAL ITEM DISPENSING |
| | | SYSTEM |
| U.S. Pat. No. 6,109,774 | Pyxis | Drawer Operating System |
| U.S. Pat. No. 6,116,461 | Pyxis | METHOD AND APPARATUS FOR THE DISPENSING OF |
| | | DRUGS |
| U.S. Pat. No. 6,139,177 | Hewlett-Packard | Device Access and Control Using Embedded Web Access |
| | | Functionality |
| U.S. Pat. No. 6,151,536 | Omnicell | Dispensing System and Method |
| U.S. Pat. No. 6,152,364 | Consumer/ | MEDICAMENT DISTRIBUTION SYSTEM AND AUTOMATIC |
| | Medimaat | DISPENSER FOR SUCH SYSTEM |
| U.S. Pat. No. 6,157,914 | Toshiba | MEDICAL SUPPORT SYSTEM |
| U.S. Pat. No. 6,163,737 | Medecorx/Diebold | MEDICAL ITEM DISPENSING APPARATUS |
| U.S. Pat. No. 6,165,154 | DEKA | CASSETTE FOR INTRAVENOUS-LINE FLOW-CONTROL |
| | | SYSTEM |
| U.S. Pat. No. 6,168,563 | HEALTH HERO | REMOTE HEALTH MONITORING AND MAINTENANCE |
| | | SYSTEM |
| U.S. Pat. No. 6,170,746 | Monarch | SYSTEM AND METHOD FOR TRACKING DRUGS IN A |
| | | HOSPITAL |
| U.S. Pat. No. 6,210,361 | Deka | System for preparing and mixing and IV Drug |
| U.S. Pat. No. 6,230,927 | Consumer/ | Automatic Drug Dispenser |
| | Medimaat | |
| U.S. Pat. No. 6,234,997 | Deka | S&M for mixing a drug in a vial. |
| U.S. Pat. No. 6,248,065 | Health Hero | MONITORING SYSTEM FOR REMOTELY QUERYING |
| | | INDIVIDUALS |
| U.S. Pat. No. 6,259,355 | ElotExecutone | PATIENT CARE AND COMMUNICATION SYSTEM |
| U.S. Pat. No. 6,266,645 | IMetrikus | Risk Adjustment Tools for Analyzing Patient Electronic Discharge |
| | | Records |
| U.S. Pat. No. 6,270,455 | Health Hero | Networked System for Interactive Communications and Remote |
| | | Monitoring of Drug Delivery |
| U.S. Pat. No. 6,272,394 | Omnicell | Methods an Apparatus for Dispensing Items |
| U.S. Pat. No. 6,317,719 | Cerner | Providing Patient-Specific Drug Information |
| U.S. Pat. No. 6,338,007 | Pyxis | System an Apparatus for the Storage and dispensing of Items |
| U.S. Pat. No. 6,339,732 | Pyxis | Apparatus and Method for Storing, Tracking and Documenting |
| | | Usage of Anesthesiology Items |
| U.S. Pat. No. 6,347,329 | Azron | Electronic Medical Records System |
| U.S. Pat. No. 6,352,200 | Consumer Health | Medicant Distribution System and Automatic Dispenser for Such |
| | | System |
| U.S. Pat. No. 6,363,282 | Medtronic | |
| U.S. Pat. No. 6,368,273 | Health Hero | Networked System for Interactive Communication and Remote |
| | | Monitoring of Individuals |
| U.S. Pat. No. 6,368,273 | Health Hero | Networked System for Interactive Communications and Remote |
| | | Monitoring of Drug Delivery |
| U.S. Pat. No. 6,371,719 | Cerner | |
| U.S. Pat. No. 6,434,531 | Clinicomp | Method and System for Facilitating Patient Care Plans |
| U.S. Pat. No. 6,464,667 | DEKA | Method and Cassette for Delivering Intravenous Drugs. |
| U.S. Pat. No. 6,470,234 | MedSelect | Medical Item Dispensing System |
| U.S. Pat. No. 6,165,154 | DEKA | Cassette for Intravenous-Line Flow-Control System |
| 2001/0007932 | DEKA | System FOR Controlling Flow Through a Line During Intravenous |
| | | Drug Delivery |
| 2001/0037220 | Medtronic | Integrated Software System for Implantable Medical Device |
| | | Installation and Management |
| 2001/0044731 | Alaris | Distributed Remote Asset and Medication Management Drug |
| | | Delivery System |
| 2002/0002473 | Cerner | Providing Patient Specific Drug Information |
| 2002/0016179 | Koninklijke Philips | Radio Communication System |
| 2002/0016719 | Cerner (Kivalo?) | Methods and Systems for Providing Medical Data to a Third Party in |
| | | Accordance with Configurable Distribution Parameters |
| 2002/0038392 | Carta Nova | Method and Apparatus for Controlling an Infusion Pump or the Like |
| 2002/0044043 | Executone | Patient Care and Communication System |
| 2002/0046346 | Azron | Electronic Medical Records System |
| 2002/0077865 | Sullivan | Computerized Risk Management Module for Medical Diagnosis |
| 2002/0082480 | Medtronic | Medical Device Systems Implemented Network Scheme for Remote |
| | | Patient Management. |
| EP 0 531 889 | Hewlett-Packard | DATA PROCESSING SYSTEM AND METHOD FOR |
| A2 | | AUTOMATICALLY PERFORMING PRIORITIZED NURSING |
| | | DIAGNOSES FROM PATIENT ASSESSMENT DATA |
| PCT/WO | Medtronic/ | INTEGRATED MEDICAL INFORMATION MANAGEMENT |
| 00/72181 A2 | Minimed | SYSTEM |
| PCT/WO | Ellora | METHOD AND APPARATUS FOR INTERNET-BASED |
| 00/78374 A1 | | ACTIVITY MANAGEMENT |

It will be understood that the invention may be embodied in other specific forms without departing from the spirit or central characteristics thereof. The present embodiments, therefore, are to be considered in all respects as illustrative and not restrictive, and the invention is not to be limited to the details given herein. While specific embodiments have been illustrated and described, numerous modifications come to mind without significantly departing from the characteristics of the invention and the scope of protection is only limited by the scope of the accompanying Claims.

What is claimed is:

1. A system for documenting a clinical intervention involving a healthcare provider and a patient comprising:
a memory for storing a documented clinical intervention.
a window enabling access to a plurality of reference codes for documenting the clinical intervention, each of the plurality of reference codes being stored within the system and include at least one pre-defined parameter, the plurality of reference codes including: problem, severity, recommendation, outcome, and status;
the problem reference code comprising a list of clinical intervention problem descriptions;
the severity reference code comprising a table of clinical intervention severity descriptions.
the recommendation reference code comprising a table of clinical intervention recommendation descriptions;
the outcome reference code comprising a table of clinical intervention outcome descriptions; and,
the status reference code comprising a table of clinical intervention status descriptions;
wherein the healthcare provider selects among the pre-defined parameters to characterize the clinical intervention.

2. The system of claim 1 further comprising:
a sub-problem reference code comprising a list of clinical intervention sub-problem descriptions.

3. The system of claim 2 further comprising:
a sub-specific reference code comprising a list of clinical intervention sub-specific problem descriptions.

4. The method of claim 1 further comprising:
a message station being capable of automatically messaging a recommendation to a specific healthcare provider.

5. The method of claim 4 further wherein the specific healthcare provider is a plurality of healthcare providers, each being a member of a unit.

6. For the system of claim 1, a method for facilitating a clinical intervention involving a healthcare provider and a patient, the method comprising the steps of:
assessing the patient's medical condition;
documenting the clinical intervention by selecting the pre-defined parameter from the plurality of reference codes;
recommending an action to address the assessed medical condition;
sending the recommendation to healthcare personnel involved with treating the patient; and,
storing the documented clinical intervention.

7. The method of claim 6 further including:
defining a potential problem;
prioritizing the recommendation;
sending a recommendation

8. A method of documenting a clinical intervention involving a healthcare provider and a patient, the method comprising the steps of:
defining a list of reference codes;
storing the list of reference codes;
displaying the list of reference codes on a screen;
enabling the reference codes to be selected for inclusion during clinical intervention documentation; and,
storing the documented clinical intervention.

9. The method of claim 8 wherein the list of reference codes comprising:
problem, severity, recommendation, outcome, and status;
the problem reference code comprising a list of clinical intervention problem descriptions;
the severity reference code comprising a table of clinical intervention severity descriptions.
the recommendation reference code comprising a table of clinical intervention recommendation descriptions;
the outcome reference code comprising a table of clinical intervention outcome descriptions; and,
the status reference code comprising a table of clinical intervention status descriptions;
wherein the healthcare provider selects among the pre-defined parameters to characterize the clinical intervention.
